(19) United States
(12) Patent Application Publication
(10) Pub. No.: US 2003/0108340 A1
(43) Pub. Date: Jun. 12, 2003

(54) Method for transferring data, storage device, its controlling method and controller for data transfer

(76) Inventors: Akiyoshi Yamashita, Ehime (JP); Masatsugu Yamahana, Ehime (JP); Takayuki Fujioka, Ehime (JP)

Correspondence Address: WALL MARJAMA & BILINSKI, 101 SOUTH SALINA STREET, SUITE 400, SYRACUSE, NY, 13202, US

(21) Appl. No.: 10/240,032

(22) PCT Filed: Jan. 28, 2002
(86) PCT No.: PCT/JP02/00588

(30) Foreign Application Priority Data
Jan. 26, 2001 (JP) 2001-17746

(51) Int. Cl. H04N 5/781

(52) U.S. Cl. 386/96; 386/125

(57) ABSTRACT

An object of the present invention is to provide a storage device having a USB interface, which transfers data in an isochronous transfer mode when the data on a recording medium attached to the storage device is video data or audio data.

An external storage device (10) having a USB interface (14) comprises a reading part (11) for reading data from a recording medium (15), a transfer mode selection part (12) which selects the isochronous transfer mode as a transfer mode when the data recorded on the recording medium (15) is video data and/or audio data, while selects a bulk transfer mode as a transfer mode when the data is not video data and/or audio data, and a data transfer part (13) for transferring the data read by the reading part (11) in the transfer mode selected by the transfer mode selection part (12).

### FIELD OF THE INVENTION

The present invention relates to a data transfer method, a storage device, a control method thereof, and a data transfer controller and, more particularly, to a data transfer method in which a transfer mode of a storage device having a USB interface is switched, the storage device which is able to switch the transfer mode, a storage device control method for controlling the transfer mode of the storage device, and a data transfer controller for controlling data transfer by the storage device.

### BACKGROUND OF THE INVENTION

As data transfer modes in devices having USB interfaces, there are following transfer modes:

1. isochronous transfer mode

2. interrupt transfer mode

3. control transfer mode

4. bulk transfer mode

In a device having a USB interface, a data transfer mode is decided according to the type of the device. For example, as a data transfer mode, the isochronous transfer mode of numeral 1 is employed for a speaker or the like, the interrupt transfer mode of numeral 2 is employed for a keyboard or a mouse, and the bulk transfer mode of numeral 4 is employed for a storage device such as a disk drive. The control transfer mode of numeral 3 is employed for transmitting/receiving a command packet concerning control of the USB device or the like.

Among the above-mentioned four transfer modes, the “bulk transfer mode” has the lowest processing priority, although it ensures contents of data. On the other hand, the “isochronous transfer mode” has the highest processing priority and ensures a data transfer rate, although it does not ensure contents of data.

A data transfer mode which is adopted for a storage device is usually “the bulk transfer mode”. The “isochronous transfer mode” is not usually used as a transfer mode of a storage device since it does not ensure contents of data.

Since a data transfer mode of a storage device having a USB interface is the bulk transfer mode having the lowest processing priority, when a device with another transfer mode exists on the USB interface, a data transfer rate of the storage device is significantly degraded, resulting in a failure such as lack of frames or sound cut during transfer of video data/audio data from the storage device.

Further, the isochronous transfer mode does not ensure contents of data although it has the highest processing priority among the USB interface transfer modes and ensures a data transfer rate. Accordingly, when only the isochronous transfer mode is employed as a transfer mode of a storage device, contents of important data is not ensured when the data is transferred.

The present invention is made to solve the above-described problems and has for its object to provide a data transfer method, a storage device, a control method thereof, and a data transfer controller, which can transfer data without generating interruption, lack of frames, and the like, of video or audio when video data and/or audio data is transferred and, further, ensure data contents when important data is transferred.

### SUMMARY OF THE INVENTION

According to the present invention, there is provided a storage device for transferring data recorded on a recording medium through a USB interface, in which the data recorded on the recording medium is transferred in a transfer mode which is selected on the basis of a result of judgement as to whether or not the data recorded on the recording medium is video data and/or audio data.

Therefore, data which have no particular problem even when the data contents have some errors, such as video data or audio data, are transferred in a transfer mode which ensures a data transfer rate, and data other than described above are transferred by a transfer mode which ensures contents of the data. Thereby, interruption, lack of frames, and the like, of video or audio being transferred, can be prevented. Further, with respect to important data such as document data, data contents are ensured.

According to the present invention, there is provided a storage device having a USB interface, comprising: a reading part for reading data from a recording medium; a transfer mode selection part which selects an isochronous transfer mode as a transfer mode when the data of a file recorded on the recording medium is video data and/or audio data, while selects a bulk transfer mode as a transfer mode when the data is not video data and/or audio data; and a data transfer part for transferring the data of the file read by the reading part in the transfer mode selected by the transfer mode selection part.

Therefore, data which have no particular problem even when the data contents have some errors, such as video data or audio data, are transferred in the isochronous transfer mode to ensure a data transfer rate, and data other than described above are transferred in the bulk transfer mode which ensures contents of the data. Thereby, interruption, lack of frames, and the like, of video or audio being transferred, can be prevented. Further, since important data such as document data are transferred in the bulk transfer mode, data contents are ensured. Furthermore, the transfer mode is decided for each file, thereby selecting a more suitable transfer mode for each file.

According to the present invention, there is provided a storage device having a USB interface, comprising: a reading part for reading data from a recording medium; a transfer mode selection part which selects an isochronous transfer mode as a transfer mode when the data recorded on the recording medium is only video data and/or audio data, while selects a bulk transfer mode as a transfer mode when the data includes data which is not video data and/or audio data; and a data transfer part for transferring the data read by the reading part in the transfer mode selected by the transfer mode selection part.

Therefore, data which have no particular problem even when the data contents have some errors, such as video data or audio data, are transferred in the isochronous transfer mode to ensure a data transfer rate, and data other than described above are transferred in the bulk transfer mode which ensures contents of the data. Thereby, interruption, lack of frames, and the like, of video or audio being transferred, can be prevented. Further, since important data such as document data are transferred in the bulk transfer mode, data contents are ensured.

According to the present invention, there is provided a data transfer controller for controlling transfer of data recorded on a recording medium that is performed by a storage device having a USB interface, in which the storage device is made to transfer the data recorded on the recording medium in a transfer mode selected on the basis of a result of judgement as to whether or not the data recorded on the recording medium is video data and/or audio data.

Therefore, it is possible to control transfer of data with selecting data transfer modes according to whether the data to be transferred are data which can be processed without problems even when the data contents have some errors, such as video data or audio data, or data other than the described above. When the video data or the audio data is transferred in a transfer mode which ensures a data transfer rate, it is possible to prevent interruption, lack of frames, and the like, of video or audio being transferred. Further, data with important contents are transferred in a transfer mode which ensures the contents of the data, thereby ensuring the data contents.

According to the present invention, there is provided a data transfer controller for controlling data transfer by a storage device having a USB interface, comprising: a data processing part for outputting a data transfer instruction for making the storage device transfer data and a mode for transferring the data on the basis of an instruction from the outside; and a data transfer control part which outputs an instruction to transfer the data in a bulk transfer mode and the data transfer instruction to the storage device when the transfer mode outputted from the data processing part is the bulk transfer mode, and outputs an instruction to transfer the data in an isochronous transfer mode and the data transfer instruction to the storage device when the transfer mode outputted from the data processing part is the isochronous transfer mode and the data is video data and/or audio data.

Therefore, control is performed so that the storage device transfers data which can be processed without problems even when the data contents have some errors, such as video data or audio data, in the bulk transfer mode or the isochronous transfer mode according to the instruction from the data processing part, and transfers data other than described above only in the bulk transfer mode. Therefore, the video data or the audio data can be transferred from the storage device in the transfer mode instructed by the data transfer controller. When the video data or the audio data is transferred in the isochronous transfer mode, it is possible to prevent interruption, lack of frames, and the like, of video or audio being transferred. Further, data with important contents are transferred only in the bulk transfer mode, thereby ensuring the data contents. Furthermore, it is possible to decide whether the data is transferred in the bulk transfer mode or the isochronous transfer mode for each file, thereby selecting a suitable transfer mode for each file.

According to the present invention, there is provided a data transfer controller for controlling transfer of data recorded on a recording medium which is performed by a storage device having a USB interface, comprising: a data processing part for outputting a data transfer instruction for making the storage device transfer data and a mode for transferring the data on the basis of an instruction from the outside; and a data transfer control part which outputs an instruction to transfer the data in a bulk transfer mode and the data transfer instruction to the storage device when the transfer mode outputted from the data processing part is the bulk transfer mode, and outputs an instruction to transfer the data in an isochronous transfer mode and the data transfer instruction to the storage device when the transfer mode outputted from the data processing part is the isochronous transfer mode and the data recorded on the recording medium is only video data and/or audio data.

Therefore, control is performed so that the storage device transfers data which can be processed without problems even when the data contents have some errors, such as video data or audio data, in the bulk transfer mode or the isochronous transfer mode according to the instruction from the data processing part, and transfers data other than described above only in the bulk transfer mode. Therefore, the video data or the audio data can be transferred from the storage device in the transfer mode instructed by the data transfer controller. When the video data or the audio data is transferred in the isochronous transfer mode, it is possible to prevent interruption, lack of frames, and the like, of video or audio being transferred. Further, data with important contents are transferred only in the bulk transfer mode, thereby ensuring the data contents.

According to the present invention, there is provided a data transfer method for transferring data recorded on a recording medium through a USB interface, in which the data recorded on the recording medium is transferred in a transfer mode selected on the basis of a result of judgement as to whether or not the data recorded on the recording medium is video data and/or audio data.

Therefore, data which have no particular problem even when the data contents have some errors, such as video data or audio data, are transferred in a transfer mode which ensures a data transfer rate, and data other than described above are transferred by a transfer mode which ensures contents of the data. Thereby, interruption, lack of frames, and the like, of video or audio being transferred, can be prevented. Further, with respect to important data such as document data, data contents are ensured.

According to the present invention, there is provided a data transfer method for transferring data recorded on a recording medium through a USB interface, comprising: a selection step of selecting an isochronous transfer mode as a transfer mode when the data of a file recorded on the recording medium is video data and/or audio data, and selecting a bulk transfer mode as a transfer mode when the data is not video data and/or audio data; and a transfer step of transferring the data of the file in the transfer mode selected in the selection step.

Therefore, data which have no particular problem even when the data contents have some errors, such as video data or audio data, are transferred in the isochronous transfer mode to ensure a data transfer rate, and data other than described above are transferred in the bulk transfer mode which ensures contents of the data. Thereby, interruption, lack of frames, and the like, of video or audio being transferred, can be prevented. Further, since important data such as document data are transferred in the bulk transfer mode, data contents are ensured. Furthermore, the transfer mode can be decided for each file, thereby selecting a more suitable transfer mode for each file.

According to the present invention, there is provided a data transfer method for transferring data recorded on a recording medium through a USB interface, comprising: a selection step of selecting an isochronous transfer mode as a transfer mode when the data recorded on the recording medium is only video data and/or audio data, and selecting a bulk transfer mode as a transfer mode when the data is not only video data or audio data; and a transfer step of transferring the data recorded on the recording medium in the transfer mode selected in the selection step.

Therefore, data which have no particular problem even when the data contents have some errors, such as video data or audio data, are transferred in the isochronous transfer mode to ensure a data transfer rate, and data other than described above are transferred in the bulk transfer mode which ensures contents of the data. Thereby, interruption, lack of frames, and the like, of video or audio being transferred, can be prevented. Further, since important data such as document data are transferred in the bulk transfer mode, data contents are ensured.

According to the present invention, there is provided a method for controlling a storage device which transfers data recorded on a recording medium through a USB interface, comprising: a judgement step of judging whether or not the data recorded on the recording medium is video data and/or audio data; a selection step of selecting a mode for transferring the data recorded on the recording medium on the basis of the judgement result in the judgement step; and a transfer step of making the storage device transfer the data recorded on the recording medium in the transfer mode selected in the selection step.

Therefore, it is possible to control transfer of data with selecting data transfer modes according to whether the data to be transferred are data which can be processed without problems even when the data contents have some errors, such as video data or audio data, or data other than the described above. When the video data or the audio data is transferred in a transfer mode which ensures a data transfer rate, it is possible to prevent interruption, lack of frames, and the like, of video or audio being transferred. Further, data with important contents are transferred in a transfer mode which ensures the contents of the data, thereby ensuring the data contents.

According to the present invention, the method for controlling the storage device further includes: an acceptance step of accepting a transfer mode of the data to be transferred by the storage device, in which method the transfer mode is selected in the selection step also on the basis of the transfer mode accepted in the acceptance step.

Therefore, it is possible to control transfer of data with selecting data transfer modes according to whether the data to be transferred are data which can be processed without problems even when the data contents have some errors, such as video data or audio data, or data other than the described above. When the video data or the audio data is transferred in a transfer mode which ensures a data transfer rate, it is possible to prevent interruption, lack of frames, and the like, of video or audio being transferred. Further, data with important contents are transferred in a transfer mode which ensures the contents of the data, thereby ensuring the data contents. Further, the transfer mode is selected also on the basis of the transfer mode accepted in the acceptance step, thereby a finer control, i.e., a control which reflects a user's intention or the like, becomes possible.

According to the present invention, there is provided a method for controlling a storage device which transfers data recorded on a recording medium through a USB interface, comprising: an acceptance step of accepting a transfer mode of the data of a file to be transferred by the storage device; a judgement step of judging whether or not the data of the file is video data and/or audio data; and a transfer step of making the storage device transfer the data of the file in a bulk transfer mode when the transfer mode accepted in the acceptance step is the bulk transfer mode, and making the storage device transfer the data of the file in an isochronous transfer mode when the transfer mode accepted in the acceptance step is the isochronous transfer mode and the data is judged to be video data and/or audio data in the judgement step.

Therefore, control is performed so that the storage device transfers data which can be processed without problems even when the data contents have some errors, such as video data or audio data, in the bulk transfer mode or the isochronous transfer mode, and transfers data other than the described above only in the bulk transfer mode. Whereby, when the video data or the audio data is transferred in the isochronous transfer mode, it is possible to prevent interruption, lack of frames, and the like, of video or audio being transferred. Further, data with important contents are transferred only in the bulk transfer mode, thereby ensuring the data contents. Furthermore, it is possible to decide whether the data is transferred in the bulk transfer mode or the isochronous transfer mode for each file, thereby selecting a suitable transfer mode for each file.

According to the present invention, there is provided a method for controlling a storage device which transfers data recorded on a recording medium through a USB interface, comprising: an acceptance step of accepting a transfer mode of the data to be transferred by the storage device; a judgement step of judging whether or not the data recorded on the recording medium is only video data and/or audio data; and a transfer step of making the storage device transfer the data recorded on the recording medium in a bulk transfer mode when the transfer mode accepted in the acceptance step is the bulk transfer mode, and making the storage device transfer the data recorded on the recording medium in an isochronous transfer mode when the transfer mode accepted in the acceptance step is the isochronous transfer mode and the data recorded on the recording medium is judged to be only video data and/or audio data in the judgement step.

Therefore, control is performed so that the storage device transfers data which can be processed without problems even when the data contents have some errors, such as video data or audio data, in the bulk transfer mode or the isochronous transfer mode according to the instruction from the data processing part, and transfers data other than described above only in the bulk transfer mode. Therefore, the video data or the audio data can be transferred from the storage device in the transfer mode instructed by the data transfer controller. When the video data or the audio data is transferred in the isochronous transfer mode, it is possible to prevent interruption, lack of frames, and the like, of video or audio being transferred. Further, data with important contents are transferred only in the bulk transfer mode, thereby ensuring the data contents.

According to the present invention, there is provided a computer-readable program recording medium in which a program for transferring data recorded on a data recording medium through a USB interface is recorded, in which program recording medium the program that makes a computer carry out a processing of transferring the data recorded on the data recording medium in a transfer mode selected on the basis of a result of judgement as to whether or not the data recorded on the data recording medium is video data and/or audio data, is recorded.

Therefore, data which have no particular problem even when the data contents have some errors, such as video data or audio data, are transferred in a transfer mode which ensures a data transfer rate, and data other than described above are transferred by a transfer mode which ensures contents of the data. Thereby, interuption, lack of frames, and the like, of video or audio being transferred, can be prevented. Further, with respect to important data such as document data, data contents are ensured.

According to the present invention, there is provided a computer-readable program recording medium in which a program for controlling a storage device that transfers data recorded on a data recording medium through a USB interface is recorded, in which program recording medium the program that makes a computer carry out the following steps is recorded: a judgement step of judging whether or not the data recorded on the data recording medium is video data and/or audio data; a selection step of selecting a mode for transferring the data recorded on the recording medium on the basis of the judgement result in the judgement step; and a transfer step of making the storage device transfer the data recorded on the recording medium in the transfer mode selected in the selection step.

Therefore, it is possible to control transfer of data with selecting data transfer modes according to whether the data to be transferred are data which can be processed without problems even when the data contents have some errors, such as video data or audio data, or data other than the described. When the video data or the audio data is transferred in a transfer mode which ensures a data transfer rate, it is possible to prevent interruption, lack of frames, and the like, of video or audio being transferred. Further, data with important contents are transferred in a transfer mode which ensures the contents of the data, thereby ensuring the data contents.

### BRIEF DESCRIPTION OF THE DRAWING

FIG. 1 is a block diagram illustrating the construction of an external storage device according to a first embodiment of the present invention;

FIG. 2 is a block diagram illustrating the construction of a data transfer controller according to the first embodiment of the invention;

FIG. 3 is a flowchart illustrating the operation of selecting a transfer mode according to the first embodiment of the invention;

FIG. 4 is a flowchart illustrating the operation of selecting a transfer mode according to a second embodiment of the present invention;

FIG. 5 is a block diagram illustrating the construction of an external storage device according to a third embodiment of the present invention;

FIG. 6 is a block diagram illustrating the construction of a data transfer controller according to the third embodiment of the invention;

FIG. 7 is a flowchart illustrating the operation of the data transfer controller according to the third embodiment of the invention;

FIG. 8 is a flowchart illustrating the operation of the data transfer controller according to the third embodiment of the invention;

FIG. 9 is a flowchart illustrating the operation of a data transfer controller according to a fourth embodiment of the present invention;

FIG. 10 is a flowchart illustrating the operation of the data transfer controller of the present invention; and

FIG. 11 is a block diagram illustrating a hardware configuration of the entire system in which the data transfer controller of the present invention is realized by employing a CPU.

### DETAILED DESCRIPTION OF THE INVENTION

### (Embodiment 1)

Hereinafter, an external storage device and a data transfer method according to a first embodiment of the present invention will be described with reference to the drawings.

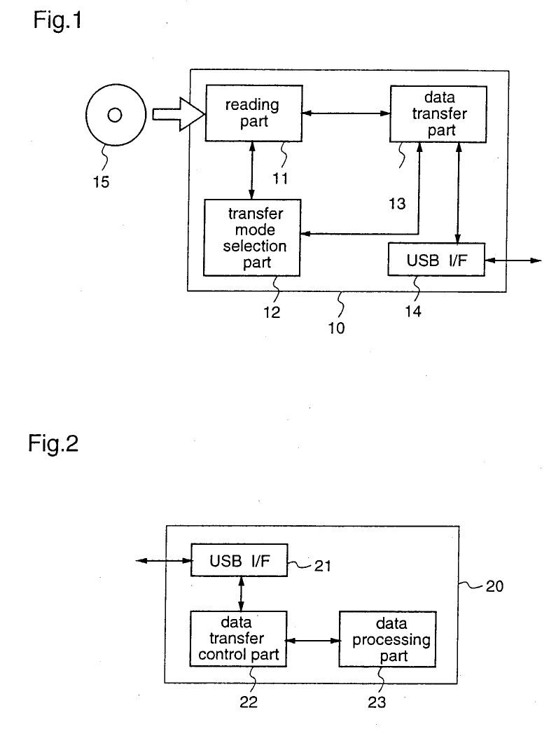

FIG. 1 is a block diagram illustrating the construction of the external storage device according to the first embodiment.

In FIG. 1, an external storage device 10 comprises a reading part 11, a transfer mode selection part 12, a data transfer part 13, and a USB interface (USB I/F) 14. A recording medium 15 according to the first embodiment is a disk-shaped medium which can be attached/detached to/from the external storage device 10.

The reading part 11 reads data from the detachable recording medium 15. The transfer mode selection part 12 selects a data transfer mode according to a type of recording medium 15, and instructs the data transfer part 13 of the selected transfer mode. The data transfer part 13 transfers the data read by the reading part 11 in the transfer mode instructed by the transfer mode selection part 12. The USB interface 14, which is an interface based on the USB standard, outputs the data from the data transfer part 13 to the outside of the external storage device 10 as well as receives data from the outside and outputs the received data to the data transfer part 13.

FIG. 2 is a block diagram illustrating the construction of a data transfer controller.

In FIG. 2, a data transfer controller 20 comprises a USB interface (USB I/F) 21, a data transfer control part 22, and a data processing part 23.

The USB interface 21 is connected with the external storage device 10. The USB interface 14 of the external storage device 10 and the USB interface 21 of the data transfer controller 20 may be connected via a USB hub. The data transfer control part 22 performs control concerning the external storage device 10. The data processing part 23 processes data received from the data transfer control part 22. Contents of the processing, for example, are as follows. When the data received from the data transfer control part 22 is video data or music data, it is outputted to a monitor (not shown) or a speaker (not shown). When the data received from the data transfer control part 22 requires some arithmetic processing, the arithmetic processing is executed.

Next, a description will be given of the operation of a system comprising the external storage device and the data transfer controller, and a data transfer method, according to the first embodiment.

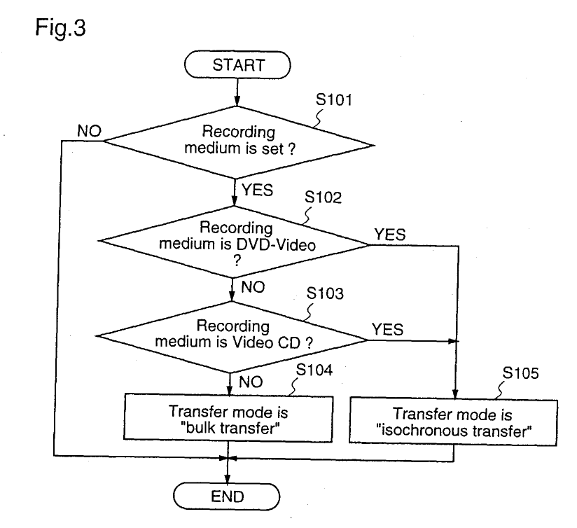

FIG. 3 is a flowchart illustrating the data transfer method in which a mode for transferring data from the external storage device 10 to the data transfer controller 20 is selected.

Initially, when there is an instruction from the data transfer controller 20 to the external storage device 10 that data recorded on the recording medium 15 is to be transferred, the reading part 11 confirms whether the recording medium 15 is set in the external storage device 10 (step S101). When the recording medium 15 is not set, the data transfer processing is ended.

When the recording medium 15 is set in the external storage device 10, the transfer mode selection part 12 judges whether the recording medium 15 is a DVD-Video or not via the reading part 11 (step S102). To be specific, when a “Video_ts” directory is placed at a root directory of the recording medium 15, and files with extensions “.ifo” and “.vob” are on that directory, the transfer mode selection part 12 judges that the recording medium 15 is a DVD-Video.

When the recording medium 15 is not a DVD-Video, the transfer mode selection part 12 judges whether the recording medium 15 is a Video CD or not via the reading part 11 (step S103). To be specific, when all the directories of “VCD”, “MPEGAV”, and “CDI” are in the root directory of the recording medium 15, the transfer mode selection part 12 judges that the recording medium 15 is a Video CD.

When the recording medium 15 is neither a DVD-Video nor a Video CD, the transfer mode selection part 12 selects a “bulk transfer mode” as a transfer mode (step S104). Then, the transfer mode selection part 12 instructs the data transfer part 13 to transfer data in the bulk transfer mode.

When the recording medium 15 is a DVD-Video or a Video CD, the transfer mode selection part 12 selects an “isochronous transfer mode” as a transfer mode (step S105). Then, the transfer mode selection part 12 instructs the data transfer part 13 to transfer data in the isochronous transfer mode.

The data transfer part 13 transfers the data from the recording medium 15 which is received through the reading part 11, to the data transfer controller 20 through the USB interface 14 in the data transfer mode instructed by the transfer mode selection part 12.

The USB interface 21 of the data transfer controller 20 receives the data transferred from the external storage device 10, and outputs the received data to the data transfer control part 22. The data transfer control part 22 judges in which transfer mode, the bulk transfer mode or the isochronous transfer mode, the data has been transferred from the external storage device 10, and outputs the judged transfer mode and the data to the data processing part 23. The data processing part 23 processes the data received from the data transfer control part 22 according to instructions from a user or in line with a predetermined procedure.

Further, the external storage device 10 may hold the transfer mode selected by the transfer mode selection part 12 in the step S104 or S105 until a new recording medium 15 is attached to the external storage device 10, so that data may be subsequently or later transferred in the held transfer mode when a data transfer instruction is issued from the data transfer controller 20. Or, it is also possible that the external storage device 10 does not hold the selected transfer mode, and selects a transfer mode for each data transfer.

The data transfer mode may be selected anytime as long as it is selected by the time the data is transferred.

As described above, according to the external storage device and the data transfer method of the first embodiment, data which have no particular problem even when the data contents have some errors, such as video data or audio data, are transferred in the isochronous transfer mode to ensure a data transfer rate, and data other than the described above are transferred in the bulk transfer mode which ensures contents of the data. Therefore, it is possible to prevent interruption, lack of frames, and the like, of video or audio transferred from the external storage device 10 to the data transfer controller 20. Further, since data with important contents such as document data are transferred in the bulk transfer mode, the data contents are ensured.

A specific method for judging whether the recording medium 15 is a DVD-Video or a Video CD is not restricted to that described in the first embodiment, and other judging methods may be also employed.

In the first embodiment, data is transferred in the isochronous transfer mode when the recording medium 15 is a DVD-Video or a Video CD. However, even when the type of recording medium 15 is other than the described above, the isochronous transfer mode may also be selected in cases where the data on the recording medium 15 is only video data and/or audio data.

### (Embodiment 2)

Hereinafter, an external storage device and a data transfer method according to a second embodiment of the present invention will be described with reference to the drawings.

The external storage device according to the second embodiment has the same construction as that of the external storage device 10 according to the first embodiment shown in FIG. 1. Further, a data transfer controller according to the second embodiment has the same construction as that of the data transfer controller 20 according to the first embodiment shown in FIG. 2. A system comprising the external storage device 10 and the data transfer controller 20 according to the second embodiment differs from the system of the first embodiment in that a transfer mode is selected for each file transferred from the external storage device 10 to the data transfer controller 20.

Next, a description will be given of the operation of the system comprising the external storage device and the data transfer controller, and a data transfer method, according to the second embodiment.

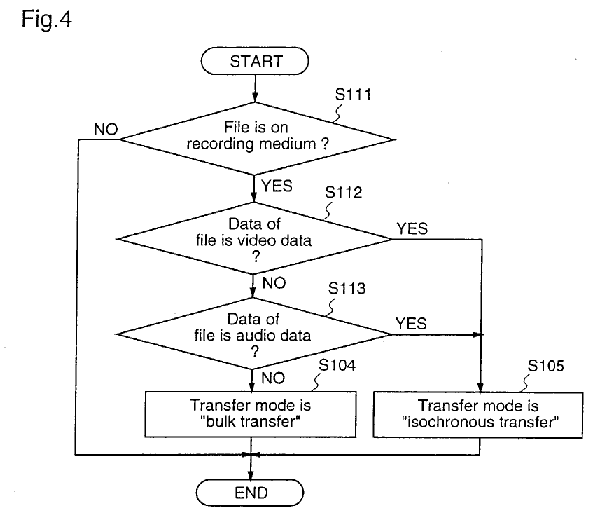

FIG. 4 is a flowchart illustrating the data transfer method in which a mode for transferring data from the external storage device 10 to the data transfer controller 20 is selected.

Initially, when there is an instruction from the data transfer controller 20 to the external storage device 10 that data of a prescribed file recorded on the recording medium 15 is to be transferred, the data transfer part 13 passes a name of the file or an identifier indicating the file to the transfer mode selection part 12. Then, the transfer mode selection part 12 confirms whether the file is on the recording medium 15 via the reading part 11 (step S111). When the file is not on the recording medium 15, the data transfer processing is ended.

When the file to be transferred to the data transfer controller 20 is on the recording medium 15, the transfer mode selection part 12 judges whether the data of the file is video data or not (step S112). To be specific, when an extension of the file is “.dat”, “.mpg” or the like, which indicates video data, and an image start position in an INFO file or a VCD file under a VCD directory and a position of a DAT file are equal, the transfer mode selection part 12 judges that the data of the file is video data.

When the file on the recording medium 15 which is to be transferred to the data transfer controller 20 is not a file of video data, the transfer mode selection part 12 judges whether the data of the file is audio data or not (step S113). To be specific, when the extension of the file is “.wav” or the like, which indicates audio data, and there exists a character string of “WAVE fmt data” at the head of the file, the transfer mode selection part 12 judges that the data of the file is audio data.

When the data of the file to be transferred to the data transfer controller 20 is neither video data nor audio data, the transfer mode selection part 12 selects a “bulk transfer mode” as a transfer mode (step S104). Then, the transfer mode selection part 12 instructs the data transfer part 13 to transfer the data in the bulk transfer mode.

When the data of the file to be transferred to the data transfer controller 20 is video data or audio data, the transfer mode selection part 12 selects an “isochronous transfer mode” as a transfer mode (step S105). Then, the transfer mode selection part 12 instructs the data transfer part 13 to transfer the data in the isochronous transfer mode.

A subsequent operation of the system is identical to that described for the first embodiment, and a description thereof will be omitted.

Even when the transfer mode selection part 12 selects “the isochronous transfer mode”, the data of the file may be transferred in the bulk transfer mode in cases where there is an instruction from the data transfer controller 20 that the data is to be transferred in the bulk transfer mode. Thus, for example, when a user transfers video data from the external storage device 10 to the data transfer controller 20 in order to record the video data on another recording medium, it is possible to select the bulk transfer mode which ensures data contents.

The data transfer mode may be selected anytime as long as it is selected by the time the data is transferred.

As described above, according to the external storage device and the data transfer method of the second embodiment, in addition to the same effect as achieved by the first embodiment, it is possible to decide whether data is transferred in the bulk transfer mode or the isochronous transfer mode for each file, thereby selecting a more suitable data transfer mode for each file.

Further, as the external storage device according to the first embodiment, it is also possible that the external storage device 10 according to the second embodiment holds the transfer mode selected in the step S104 or S105 correspondingly to a name or identifier of a file, so that data is transferred according to that transfer mode when the external storage device 10 receives an instruction to transfer the held file from the data transfer controller 20, while the external storage device 10 may select a transfer mode by the processing shown in FIG. 4 when receiving an instruction to transfer a file other than the held file. Or, it is also possible that the external storage device 10 does not hold a transfer mode and selects a transfer mode according to the method shown in FIG. 4 each time the external storage device 10 receives a transfer instruction.

While in the second embodiment the video data or the audio data has been described as the data in the format of a file having an extension such as “. dat”, “.mpg”, or “.wav”, video data or audio data in file formats other than described above are also possible. Further, a method for judging whether the data is audio data or video data is not restricted to that described in the second embodiment.

In the first and second embodiments, a program indicating the procedure for selecting a transfer mode shown in FIG. 3 or 4 may be incorporated in a firmware of the external storage device 10, so as to operate the respective constituents of the external storage device 10.

### (Embodiment 3)

Hereinafter, an external storage device, a control method of the storage device, and a data transfer controller according to a third embodiment of the present invention will be described with reference to the drawings.

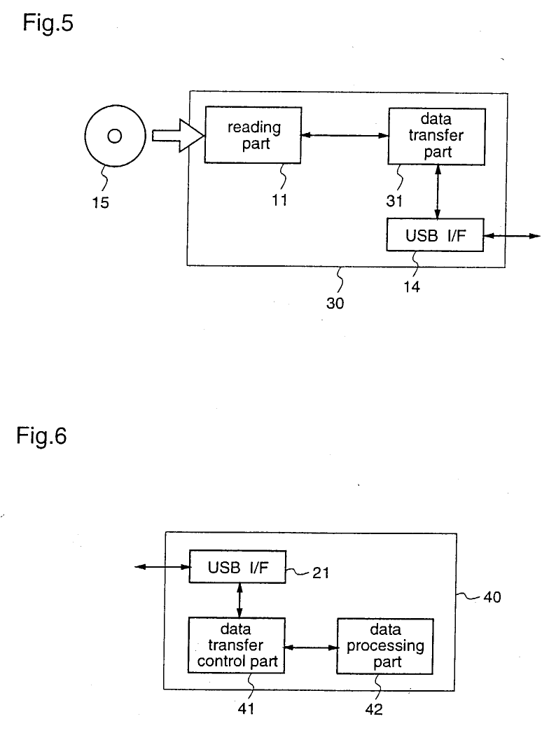

FIG. 5 is a block diagram illustrating the construction of the external storage device having a USB interface according to the third embodiment.

In FIG. 5, an external storage device 30 comprises a reading part 11, a USB interface (USB I/F) 14, and a data transfer part 31. The reading part 11 and the USB interface 14 are identical to those described for the first embodiment in FIG. 1, and descriptions thereof will be omitted.

The data transfer part 31 transfers data which is read from a recording medium 15 by the reading part 11 according to a data transfer mode instructed by a data transfer controller 40 connected with the external storage device 30.

FIG. 6 is a block diagram illustrating the construction of the data transfer controller having a USB interface according to the third embodiment.

In FIG. 6, the data transfer controller 40 comprises a USB interface (USB I/F) 21, a data transfer control part 41, and a data processing part 42.

The USB interface 21 is connected with the external storage device 30. The USB interface 14 of the external storage device 30 and the USB interface 21 of the data transfer controller 40 may be connected via a USB hub.

In addition to the function of the data transfer control part 22 of the first embodiment shown in FIG. 2, the data transfer control part 41 judges whether the recording medium 15 attached to the external storage device 30 is a DVD-Video or a Video CD, selects a data transfer mode on the basis of the judgement result and an instruction from the data processing part 42, and instructs the external storage device 30 of the selected transfer mode. The data processing part 42 not only issues an instruction to transfer data to the external storage device 30 but also instructs the data transfer control part 41 of the data transfer mode.

Next, a description will be given of the operation of a system comprising the external storage device and the data transfer controller, and a control method of the storage device, according to the third embodiment,.

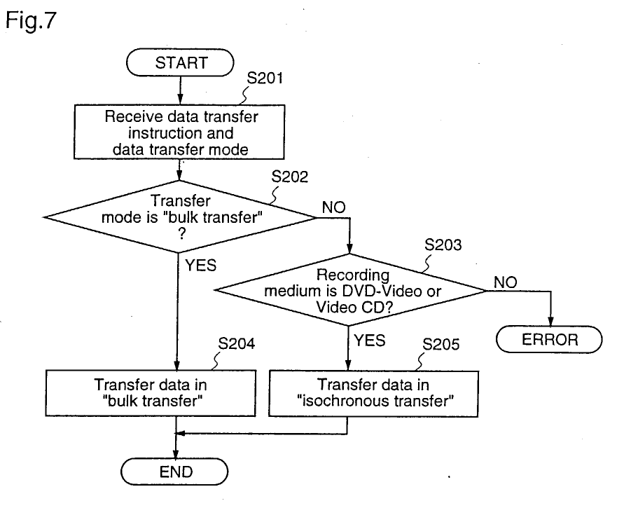

FIG. 7 is a flowchart illustrating the operation of the data transfer control part 41 according to the third embodiment.

Initially, with an instruction from a user, which is inputted from the outside of the data processing part 42, or an instruction to transfer a prescribed data which is a part of a series of processing program, the data processing part 42 instructs the data transfer control part 41 of a data transfer instruction including an identifier of the data to be transferred from the external storage device 30 and a mode for transferring the data.

The data transfer control part 41 receives the data transfer instruction and the transfer mode from the data processing part 42 (step S201).

Then, the data transfer control part 41 judges whether the received transfer mode is a “bulk transfer mode” or not (step S202). When the transfer mode received from the data processing part 42 is the “bulk transfer mode”, the data transfer control part 41 outputs the data transfer instruction and an instruction to transfer the data in the “bulk transfer mode”, to the external storage device 30 (step S204).

On the other hand, when the transfer mode received from the data processing part 42 is an “isochronous transfer mode”, the data transfer control part 41 judges whether the recording medium 15 in the external storage device 30 is a DVD-Video or a VideoCD via the USB interface 21, and the USB interface 14, the data transfer part 31, and the reading part 11 of the external storage device 30, by the method as described for the first embodiment (step S203). When the recording medium 15 is neither a DVD-Video nor a Video CD, the data transfer control part 41 returns an error to the data processing part 42. Thus, when the recording medium 15 is neither a DVD-Video nor a Video CD, it is possible to prevent data which is not video data or audio data from being transferred in the isochronous transfer mode. When the recording medium 15 is a DVD-Video or a Video CD, the data transfer control part 41 outputs an instruction to transfer the data in the “isochronous transfer mode” and the data transfer instruction, to the external storage device 30 (step S205).

The instruction concerning control from the data transfer controller 40 to the external storage device 30 is issued by transferring a command packet in a control transfer mode. For example, when the data transfer controller 40 transmits the instruction to transfer the data in the bulk transfer mode, to the external storage device 30, the data transfer controller 40 transmits a command packet in which information indicating the bulk transfer mode is added at a prescribed position, to the external storage device 30.

When the external storage device 30 receives the data transfer instruction and the data transfer mode from the data transfer controller 40, the data transfer part 31 receives data corresponding to the identifier included in the data transfer instruction through the reading part 11, and transfers the data to the data transfer controller 40 in the instructed data transfer mode. Then, the data transfer controller 40 can receive the desired data transferred in the instructed transfer mode.

As described above, according to the external storage device, the control method of the storage device, and the data transfer controller 40 of the third embodiment, control is performed so that the external storage device 30 transfers data which can be processed without problems even when the data contents have some errors, such as video data and audio data, in the bulk transfer mode or the isochronous transfer mode according to the instruction from the data processing part 42, while control is performed so that the external storage device 30 transfers data other than the described above only in the bulk transfer mode. Therefore, the video data or the audio data can be transferred from the external storage device 30 in the transfer mode instructed by the data transfer controller 40. When the video data or the audio data is transferred in the isochronous transfer mode, it is possible to prevent interruption, lack of frames, and the like, of video or audio being transferred. Further, since data with important contents are transferred only in the bulk transfer mode, the data contents are ensured.

In the third embodiment, the data transfer control part 41 instructs the external storage device 30 to transfer the data in the isochronous transfer mode when the recording medium 15 is a DVD-Video or a Video CD, in steps S203 and S205. However, even when the recording medium 15 is neither a .DVD-Video nor a Video CD, the data may be transferred in the isochronous transfer mode in cases where the data recorded on the recording medium 15 is only video data and/or audio data.

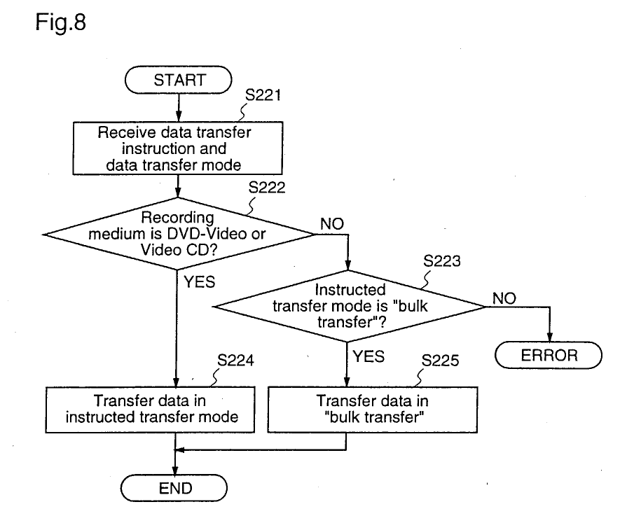

Further, while in the third embodiment the data transfer control part 41 checks the type of recording medium 15 after judging the kind of transfer mode received from the data processing part 42 as shown in the flowchart in FIG. 7, the present invention is not restricted thereto. For example, as shown in FIG. 8, when the data transfer control part 41 receives the data transfer instruction and the transfer mode from the data processing part 42 (step S221), the data transfer control part 41 initially judges the type of recording medium 15 (step S222) and, then, judges whether the transfer mode received in the step S221 is the bulk transfer mode or not (step S223). As the result of the judgement, when the recording medium 15 is a DVD-Video or the like, the external storage device 30 is made to transfer the data in the transfer mode instructed by the data processing part 42 (step S224). When the recording medium 15 is not a DVD-Video or the like, and the transfer mode instructed by the data processing part 42 is the “bulk transfer mode”, it is possible that the external storage device 30 is made to transfer the data in the bulk transfer mode (step S225). The data transfer control part 41 may receive the transfer mode from the data processing part 42 after judging the type of recording medium 15.

As described above, according to the present invention, as to the timing when the data transfer control part 41 judges the type of recording medium and the timing when the data transfer control part 41 judges whether the instructed transfer mode is the “bulk transfer mode” or not, their sequence is not restricted.

### (Embodiment 4)

Hereinafter, an external storage device, a control method of the storage device, and a data transfer controller according to a fourth embodiment of the present invention will be described with reference to the drawings.

The external storage device according to the fourth embodiment has the same construction as that of the external storage device 30 according to the third embodiment shown in FIG. 5. Further, the data transfer controller according to the fourth embodiment has the same construction as that of the data transfer controller 40 according to the third embodiment shown in FIG. 6. A system comprising the external storage device 30 and the data transfer controller 40 of the fourth embodiment differs from the system according to the third embodiment in that a transfer mode is selected for each file transferred from the external storage device 20 to the data transfer controller 40. Thus, the data transfer control part 41 according to the fourth embodiment judges whether data recorded on the recording medium 15 is video data or audio data for each file.

Next, a description will be given of the operation of the system comprising the external storage device and the data transfer controller, and a control method of the storage device, according to the fourth embodiment.

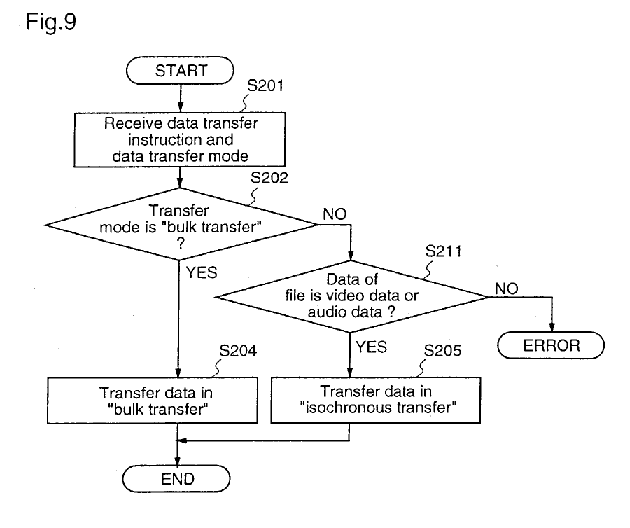

FIG. 9 is a flowchart for illustrating the operation of the data transfer control part 41 according to the fourth embodiment.

In FIG. 9, process steps other than step S211 is identical to those described for the third embodiment in FIG. 7, and a description thereof will be omitted.

In step S211, the data transfer control part 41 judges whether data of a file which is to be transferred by the external storage device 30 according to the data transfer instruction received in step S201 is video data or audio data, via the USB interface 21, and the USB interface 14, the data transfer part 31, and the reading part 11 of the external storage device 30 by the method described for the second embodiment. When the data is neither video data nor audio data, the data transfer control part 41 returns an error to the data processing part 42. Thus, it is possible to prevent data from the recording medium 15, which is not video data or audio data from being transferred in the isochronous transfer mode. On the other hand, when the data of the file which is to be transferred by the external storage device 30 is video data or audio data, the processing proceeds to step S205.

As described above, according to the external storage device, the control method of the storage device, and the data transfer controller 40 of the fourth embodiment, in addition to the same effect as achieved by the third embodiment, it is possible to decide whether data is transferred in the bulk transfer mode or the isochronous transfer mode for each file, thereby selecting a suitable transfer mode for each file.

In the step S211 of the fourth embodiment, even when the video data or the audio data is in a file format other than those described for the second embodiment, the data transfer control part 41 may control the external storage device 30 so that the data is transferred in the isochronous transfer mode in cases where the data of the file is video data and/or audio data.

In the fourth embodiment, the data transfer control part 41 judges whether the data to be transferred is video data or audio data after judging the transfer mode received from the data processing part 42 (step S202). However, for example, as shown in the flowchart of the third embodiment in FIG. 8, the data transfer control part 41 may judge the kind of instructed transfer mode after judging the type of data to be transferred also in this fourth embodiment.

Further, while in the third and fourth embodiments the data transfer control part 41 judges the type of recording medium 15 or the kind of data of a file to be transferred after receiving the data transfer instruction and the transfer mode from the data processing part 42, the present invention is not restricted thereto. For example, it is also possible that the type of recording medium 15 or the kind of data of a file recorded on the recording medium 15 is judged when the data transfer controller 40 receives a disk change notice that a new recording medium 15 is attached, from the external storage device 30.

Furthermore, in the third and fourth embodiments, the data transfer control part 41 may select a transfer mode by the method as shown in FIG. 3 or 4 regardless of the instruction from the data processing part 42, and instruct the external storage device 30 of the transfer mode selected in the step S104 or S105.

While in the third and fourth embodiments the external storage device 30 transfers data which is instructed by the data transfer controller 40 to the data transfer controller 40, the destination to which the external storage device 30 transfers the data is not restricted to the data transfer controller 40, for example, the data may be also transferred to a data processor (not shown) other than the data transfer controller 40.

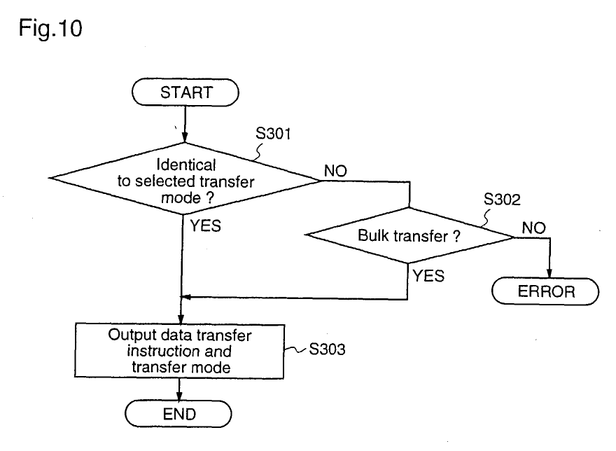

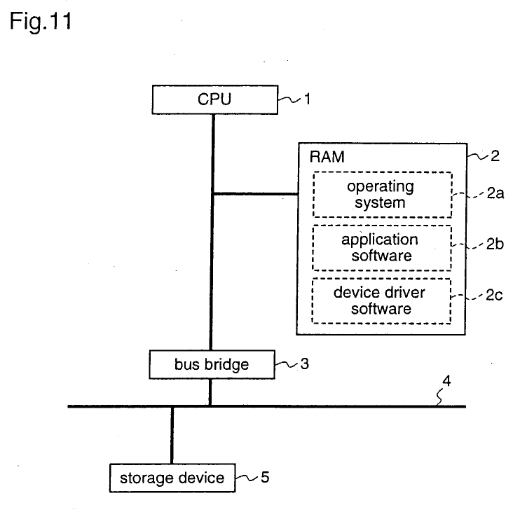

Further, in the third and fourth embodiments, it is also possible that the data transfer control part 41 previously selects a provisional transfer mode by the method as shown in FIG. 3 or 4 and, then, decides a final transfer mode by the method as shown in the flowchart in FIG. 10.

In FIG. 10, the data transfer control part 41 judges whether the transfer mode received from the data processing part 42 and the transfer mode provisionally selected in the step S104 or S105 are identical or not (step S301). When they are different, the data transfer control part 41 judges whether the transfer mode received from the data processing part 42 is the bulk transfer mode or not (step S302). When the transfer mode received from the data processing part 42 is not the bulk transfer mode, the data transfer control part 41 returns an error to the data processing part 42. When the transfer mode received from the data processing part 42 and the provisionally selected transfer mode are identical in the step S301, or the transfer mode received from the data processing part 42 is the bulk transfer mode in the step S302, the data transfer control part 41 outputs the transfer mode received from the data processing part 42 and the data transfer instruction to the external storage device 30 (step S303). Also in this way, the same effect as achieved by the third or fourth embodiment can be obtained.

The external storage device in each of the above-described embodiments is not restricted to one which is set physically outside but may be a storage device which is set inside some device as long as the storage device has the USB interface so as to transfer data thereby.

While in each of the embodiments the recording medium 15 can be attached/detached to/from the storage device, and is a read-only disk-shaped recording medium, i.e., a DVD-Video and a Video CD, the present invention is not restricted thereto. That is, the recording medium used in the present invention need not be detachable, and may be a recordable recording medium and, further, a non disk-shaped recording medium such as a tape-shaped recording medium like a magnetic tape or a nonvolatile semiconductor memory.

As the recording medium, there is employed, for example, an optical disk such as a CD-ROM, a CD-R, a CD-RW, a DVD-ROM, a DVD-RAM, a DVD-R, and DVD-RW, a magneto-optical disk such as an MO, a magnetic disk such as a hard disk, a semiconductor memory, a magnetic tape or the like.

FIG. 11 is a block diagram illustrating a hardware configuration of the entire system when the data transfer controller according to each of the embodiments is realized by employing a CPU 1.

In FIG. 11, the system comprises the CPU 1, a RAM 2, a bus bridge 3, peripheral device connection bus 4, and a storage device 5. The storage device 5 corresponds to the external storage device 10 of the first and second embodiments as well as the external storage device 30 of the third and fourth embodiments, and is connected with the peripheral device connection bus 4 via a USB interface. Further, the bus bridge 3 and the peripheral device connection bus 4 are also connected via a USB interface.

The CPU 1 performs a data arithmetic processing, control of the storage device 5 or the like according to an operating system 2a and an application software 2b stored in the RAM 2. Further, the CPU 1 controls the storage device 5 according to a device driver software 2c stored in the RAM 2. Here, the device driver software 2c is a program including a program for making the CPU 1 execute the processing of selecting a data transfer mode shown in FIGS. 3, 4, and 7-10. All or part of the processing may be performed by the operating system (OS) 2a.

As described above, the data transfer controller according to the present invention may be constructed by a hardware or a software by the program control as shown in FIG. 11.

As a program recording medium for recording the program, there can be employed, for example, a floppy(registered trademark) disk, a hard disk, an optical disk, a magnetic disk, a magneto-optical disk, a CD-ROM, a DVD-RAM, a magnetic tape, a nonvolatile memory card, a ROM or the like.

### Applicability in Industry

As described above, a data transfer method, a storage device, a control method thereof, and a data transfer controller according to the present invention relate to data transfer through a USB interface and are suitable for data between a PC (Personal Computer) and a hard disk, or the like.

We claim:

1. A storage device for transferring data recorded on a recording medium through a USB interface, wherein
the data recorded on the recording medium is transferred in a transfer mode which is selected on the basis of a result of judgement as to whether or not the data recorded on the recording medium is video data and/or audio data.

2. A storage device having a USB interface comprising:
a reading part for reading data from a recording medium;
a transfer mode selection part for selecting an isochronous transfer mode as a transfer mode when data of a file recorded on the recording medium is video data and/or audio data, and selecting a bulk transfer mode as a transfer mode when the data is not video data and/or audio data; and
a data transfer part for transferring the data of the file read by the reading part, in the transfer mode selected by the transfer mode selection part.

3. A storage device having a USB interface comprising:
a reading part for reading data from a recording medium;
a transfer mode selection part for selecting an isochronous transfer mode as a transfer mode when the data recorded on the recording medium is only video data and/or audio data, and selecting a bulk transfer mode as a transfer mode when the data includes data which is not video data and/or audio data; and
a data transfer part for transferring the data read by the reading part, in the transfer mode selected by the transfer mode selection part.

4. A data transfer controller for controlling transfer of data recorded on a recording medium, which transfer is performed by a storage device having a USB interface, wherein
the storage device is made to transfer the data recorded on the recording medium, in a transfer mode which is selected on the basis of a result of judgement as to whether or not the data recorded on the recording medium is video data and/or audio data.

5. A data transfer controller for controlling data transfer by a storage device having a USB interface, comprising:
a data processing part for outputting a data transfer instruction for making the storage device transfer data and a mode for transferring the data, on the basis of an instruction from the outside; and
a data transfer control part for outputting an instruction to transfer the data in a bulk transfer mode and the data transfer instruction to the storage device when the transfer mode outputted from the data processing part is the bulk transfer mode, and outputting an instruction to transfer the data in an isochronous transfer mode and the data transfer instruction to the storage device when the transfer mode outputted from the data processing part is the isochronous transfer mode and the data is video data and/or audio data.

6. A data transfer controller for controlling transfer of data recorded on a recording medium, which transfer is performed by a storage device having a USB interface, comprising:
a data processing part for outputting a data transfer instruction for making the storage device transfer data and a mode for transferring the data, on the basis of an instruction from the outside; and
a data transfer control part for outputting an instruction to transfer the data in a bulk transfer mode and the data transfer instruction to the storage device when the transfer mode outputted from the data processing part is the bulk transfer mode, and outputting an instruction to transfer the data in an isochronous transfer mode and the data transfer instruction to the storage device when the transfer mode outputted from the data processing part is the isochronous transfer mode and the data recorded on the recording medium is only video data and/or audio data.

7. A data transfer method for transferring data recorded on a recording medium through a USB interface, wherein
the data recorded on the recording medium is transferred in a transfer mode which is selected on the basis of a result of judgement as to whether or not the data recorded on the recording medium is video data and/or audio data.

8. A data transfer method for transferring data recorded on a recording medium through a USB interface, comprising:
a selection step of selecting an isochronous transfer mode as a transfer mode when data of a file recorded on the recording medium is video data and/or audio data, and selecting a bulk transfer mode as a transfer mode when the data is not video data and/or audio data; and
a transfer step of transferring the data of the file in the transfer mode selected in the selection step.

9. A data transfer method for transferring data recorded on a recording medium through a USB interface, comprising:
a selection step of selecting an isochronous transfer mode as a transfer mode when the data recorded on the recording medium is only video data and/or audio data, and selecting a bulk transfer mode as a transfer mode when the data is not only video data or audio data; and
a transfer step of transferring the data recorded on the recording medium in the transfer mode selected in the selection step.

10. A method for controlling a storage device which transfers data recorded on a recording medium through a USB interface, comprising:
a judgement step of judging whether or not the data recorded on the recording medium is video data and/or audio data;
a selection step of selecting a mode for transferring the data recorded on the recording medium, on the basis of the judgement result in the judgement step; and
a transfer step of making the storage device transfer the data recorded on the recording medium, in the transfer mode selected in the selection step.

11. The method for controlling the storage device as defined in claim 10, further including:
an acceptance step of accepting a transfer mode of data to be transferred by the storage device, wherein
the transfer mode is selected in the selection step also on the basis of the transfer mode accepted in the acceptance step.

12. A method for controlling a storage device which transfers data recorded on a recording medium through a USB interface, comprising:
an acceptance step of accepting a transfer mode of the data of a file to be transferred by the storage device;
a judgement step of judging whether or not the data of the file is video data and/or audio data; and
a transfer step of making the storage device transfer the data of the file in a bulk transfer mode when the transfer mode accepted in the acceptance step is the bulk transfer mode, and making the storage device transfer the data of the file in an isochronous transfer mode when the transfer mode accepted in the acceptance step is the isochronous transfer mode and the data is judged to be video data and/or audio data in the judgement step.

13. A method for controlling a storage device which transfers data recorded on a recording medium through a USB interface, comprising:
an acceptance step of accepting a transfer mode of the data to be transferred by the storage device
a judgement step of judging whether or not the data recorded on the recording medium is only video data and/or audio data; and
a transfer step of making the storage device transfer the data recorded on the recording medium in a bulk transfer mode when the transfer mode accepted in the acceptance step is the bulk transfer mode, and making the storage device transfer the data recorded on the recording medium in an isochronous transfer mode when the transfer mode accepted in the acceptance step is the isochronous transfer mode and the data recorded on the recording medium is judged to be only video data and/or audio data in the judgement step.

14. A computer-readable program recording medium in which a program for transferring data recorded on a data recording medium through a USB interface is recorded, wherein
a program for making a computer carry out a process of transferring the data recorded on the data recording medium in a transfer mode which is selected on the basis of a result of judgement as to whether or not the data recorded on the data recording medium is video data and/or audio data, is recorded.

15. A computer-readable program recording medium in which a program for controlling a storage device that transfers data recorded on a data recording medium through a USB interface is recorded, wherein
a program for making a computer carry out the following steps is recorded:
a judgement step of judging whether, or not the data recorded on the data recording medium is video data and/or audio data;
a selection step of selecting a mode for transferring the data recorded on the recording medium, on the basis of the judgement result in the judgement step; and
a transfer step of making the storage device transfer the data recorded on the recording medium, in the transfer mode selected in the selection step.
